(19) United States
(12) Patent Application Publication
(10) Pub. No.: US 2025/0310852 A1
(43) Pub. Date: Oct. 2, 2025

(54) DYNAMIC GLOBAL NETWORK CONNECTIVITY ORCHESTRATOR FOR RESOURCE LIMITED MOBILE DEVICES

(71) Applicant: Microsoft Technology Licensing, LLC, Redmond, WA (US)

(72) Inventors: Vaishnavi NATTAR RANGANATHAN, Woodinville, WA (US); Ranveer CHANDRA, Kirkland, WA (US); Tusher CHAKRABORTY, Bellevue, WA (US)

(21) Appl. No.: 18/625,175

(22) Filed: Apr. 2, 2024

(51) Int. Cl. H04W 36/32; H04W 36/14

(52) U.S. Cl. CPC H04W 36/322; H04W 36/14

(57) ABSTRACT

Examples provide improved methods for managing wireless network connectivity for a mobile device. Examples include receiving a network map that defines geographic availability of a first wireless network; determining that the first wireless network is accessible within a travel segment of a travel plan based on comparing geographic location data associated with the travel segment to the geographic availability of the first wireless network from the network map; creating a network plan that includes the travel segment and an associated connectivity waypoint, the connectivity waypoint defining when to alter connectivity status with the first wireless network; and causing the mobile device to alter connectivity status with the first wireless network based on proximity to the connectivity waypoint.

### BACKGROUND

Some common types of wireless networks include cellular networks, satellite networks, and Wi-Fi networks. Cellular networks utilize a large tower to provide connectivity to cellular devices over a relatively wide area around the tower. The connectivity area ignores obstructions, such as buildings, between the tower and the cellular device. Satellite networks utilize low earth orbit satellites to provide network connectivity to a mobile device equipped with hardware to send and receive data from the satellite. Unlike cellular networks, satellite networks are sensitive to obstructions between the satellite and the mobile device. This sensitivity makes satellite networks difficult to connect to, within cities. However, satellite networks do not require proximity to a tower giving them a potentially larger area of coverage. Wi-Fi networks utilize a router and modem to provide a short range of connectivity to devices. This range is often limited to a single building with large buildings requiring multiple routers to provide coverage.

As a mobile device is moving, the mobile device may encounter a loss of connectivity with its primary network (e.g., a preferred cellular network). To retain network connectivity and communications, the mobile device can be configured to connect to another network (e.g., a cellular network of another provider). However, choosing the “best” network optimized for the mobile device is difficult.

### SUMMARY

The disclosed examples are described in detail below with reference to the accompanying drawing figures listed below. The following summary is provided to illustrate some examples disclosed herein. The following is not meant, however, to limit all examples to any particular configuration or sequence of operations.

Example solutions for managing wireless network connectivity for a mobile device include: receiving a network map that defines geographic availability of a first wireless network; determining that the first wireless network is accessible within a travel segment of a travel plan based on comparing geographic location data associated with the travel segment to the geographic availability of the first wireless network from the network map; creating a network plan that includes the travel segment and an associated connectivity waypoint, the connectivity waypoint defining when to alter connectivity status with the first wireless network; and causing the mobile device to alter connectivity status with the first wireless network based on proximity to the connectivity waypoint.

### BRIEF DESCRIPTION OF THE DRAWINGS

The disclosed examples are described in detail below with reference to the accompanying drawing figures listed below:

FIG. 1 is a diagram illustrating an example travel path of a vehicle, including wireless network availability along the travel path;

FIG. 2 is an architectural diagram illustrating an example dynamic network planning system for managing network connectivity of a mobile edge device;

FIG. 3 is a diagram illustrating the example travel path of the vehicle of FIG. 1, showing wireless network availability of multiple wireless networks along the travel path;

FIG. 4 is a flow chart of an example method for managing wireless network connectivity for a mobile device; and

FIG. 5 is a block diagram of an example computing device (e.g., a computer storage device) for implementing aspects disclosed herein, and is designated generally as computing device.

Corresponding reference characters indicate corresponding parts throughout the drawings. Any of the figures may be combined into a single example or embodiment.

### DETAILED DESCRIPTION

One of the challenges faced by global trade is the ability to track and connect information about the goods and services as they travel from origin to destination. While wireless mobile communication has bridged the gap between people across the world, a cost-efficient equivalent does not exist, with existing systems, for the network of mobile devices that travel the world. Moreover, mobile network coverage is often limited to urban areas.

The data transferred by the mobile device to a network depends on the specific application running on the device. For example, a mobile device for a transportation vehicle transfers global positioning system (GPS) location data of the vehicle, moisture or temperature data of cargo being transported by the vehicle, or other such status information associated with the vehicle or its cargo. Such data may be shared with a monitoring server or other such logistics infrastructure, thereby allowing a carrier to view status and manage a fleet of vehicles. Networks are often chosen based on the need of the devices, as well other factors such as cost, projected travel paths and coverage, and data throughput. For example, a network that primarily provides coverage only in metropolitan areas is chosen for a fleet that predominantly operates in cities. For carriers that operate fleets across larger expanses (e.g., nationwide), a network that provides greater availability may be chosen.

In such shipping or other such fleet management operations, a transportation manager remotely manages a fleet of vehicles (e.g., manned or unmanned/autonomous trucks, vans, tankers, trains, ships, or the like) and/or cargo that may be transported by such vehicles (e.g., trailers, containers, packages, or the like). The transportation manager may wish to remotely track and manage their vehicles or cargo, such as through use of mobile devices that travel with the vehicles or cargo and that can wirelessly connect and transfer data from the mobile device to a remote infrastructure, such as a fleet management system.

A common issue for mobile devices is retaining network connectivity while traveling. Frequently, a mobile device can pass through an area in which the mobile device cannot establish or maintain connectivity with a preferred wireless network (e.g., where the primary network provider does not provide coverage, or where the wireless network is otherwise obstructed from the mobile device). In such situations, the mobile device loses network connectivity to the preferred network, and thus to the remote system. However, there may be multiple wireless networks available to the mobile device at various times during travel. In addition to differing coverage areas, various wireless networks can have different properties, such as data transfer speed, data transfer cost, or connectivity costs. However, conventional mobile devices are traditionally limited to one particular network during their travels, and thus may be limited by the resources and parameters of that one network.

Further, different use cases often include differing network connectivity demands and restrictions, such as data rates, cost-efficient connectivity, resource-limited mobile devices, and communication latency. For example, with supply chain use cases, pervasive connectivity enables timely monitoring of goods to provide precise information that track location, handling and the necessary information to meet certification requirements securely. This can also help avoid breaks in the supply chain caused by unforeseen changes to network availability. For automated vehicles and drones, low-latency dynamic connectivity makes dynamic path planning and adaptation possible on limited resources and at optimized cost. This enables specific tasks like adapting for route changes, traffic and destination changes as well as long range operation. Reliable and predictable connectivity becomes critical to ensure safety and efficiency of such a service.

An example dynamic network planning system for mobile devices is described herein. In examples, a transportation manager uses the network planning system to manage network connectivity for a fleet of vehicles or cargo units during travel, where each vehicle or cargo unit is configured with an associated mobile device. The network planning system plans and orchestrates network connectivity for the mobile devices, allowing the mobile devices to establish connectivity to various wireless networks as the vehicle or cargo travels.

These network connectivity plans are used by the mobile device to maintain network connectivity to particular networks at particular times during their travel. For example, the system manages a fleet of autonomous trucks, each of which includes a mobile device that facilitates wireless network connectivity with the planning server. This wireless network connectivity allows the system to receive real-time data from each vehicle, such as current vehicle data (e.g., geolocation data of the vehicle, travel speed) and/or status information of cargo transported by the vehicle (e.g., temperature, humidity, or other sensor data).

In some examples, the system includes a planning server that creates and deploys network connectivity plans for mobile devices. During a planning phase, the planning server receives route information for a mobile device (e.g., one of the fleet vehicles or cargo) and generates a network connectivity plan for the mobile device along its planned travel route. The planning server uses a network map to identify which network(s) are available along various segments of the travel route. Using this network map, the planning server determines which network is preferred for use at each segment of the travel route. Such determination can be based on parameter priorities, such as connectivity or data transfer cost, data transfer rate, latency of communication, and network availability. At each segment of the travel plan, the network connectivity plan includes a ranked list of preferred networks. This allows the mobile device to connect to the most preferable network based on the priorities at each segment of its travel route.

After the network connectivity plan is created and transferred to the mobile device, the system enters a dynamic update phase. In this phase, the mobile device implements the network connectivity plan as the vehicle transits its travel route. When the vehicle enters a new segment of the travel route, the mobile device uses the network connectivity plan to identify the most preferred network for that particular segment (e.g., the first network identified for that segment) and connects to that network (e.g., a preferred cellular network). In situations where the most preferred network is not available, the mobile device then uses the network connectivity plan to identify the next most preferred network and connects to that network (e.g., another cellular network, a satellite network, or such), at least until connectivity to a more preferred network is available or until the mobile device moves into another travel segment. As such, the system allows the mobile device to manage its own network connectivity based on the plan, dynamically adjusting to network interruptions in a controlled manner.

Further, real time information is also collected from the mobile device and used to update the network connectivity plan during this phase. This may include updating the network map, updates to contingencies, and updates to other databases (e.g., weather, traffic). For example, if the vehicle encounters an accident that shuts down or creates a large volume of traffic on a major highway, the vehicle may choose to take an alternate route. This alternate route may not be within the scope of the existing network connectivity plan. In such situations, the planning server may generate an updated plan for the new route and share that new plan with the mobile device.

Example solutions facilitate managing wireless network connectivity for mobile devices, such as with fleets of vehicles, as they travel. The systems and methods described herein use a network map that defines geographic availability of wireless networks in conjunction with a travel plan of the mobile device to determine which wireless networks are accessible at various points according to the travel plan. The system compares geographic location data for a travel segment to the geographic availability of wireless networks from the network map to create a network plan that the mobile device will use during travels. The network plan includes at least one connectivity waypoint for each travel segment, which defines when the mobile device will alter its connectivity status with wireless networks. The network plan also defines an ordered list of network preferences, directing the mobile device to connect to a most preferred network during a given travel segment, if that network is available, and providing other networks that can be used if that first network is not accessible. The combination of advanced connectivity planning, based on a projected travel path, in conjunction with dynamic implementation of the network plan by the mobile device itself, allows the device operator to maximize device connectivity to wireless networks, thereby increasing the connectivity time between the mobile device and the network, as well as to improve network communications of the mobile device by connecting to preferred networks that, for example, offer lower latency or greater bandwidth.

The various examples are described in detail with reference to the accompanying drawings. Wherever preferable, the same reference number is used throughout the drawings to refer to the same or like part. References made throughout this disclosure relating to specific examples and implementations are provided solely for illustrative purposes but, unless indicated to the contrary, are not meant to limit all examples.

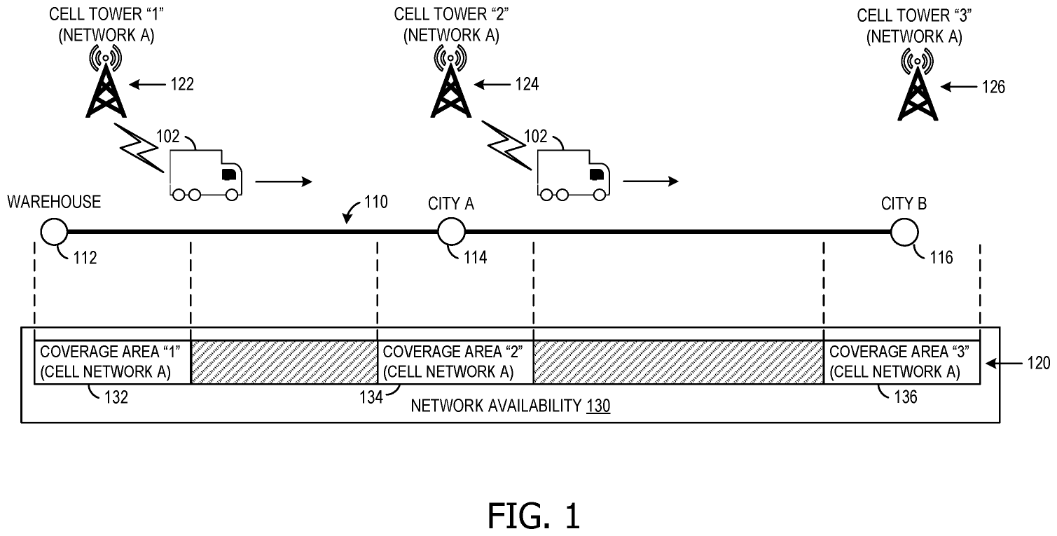

FIG. 1 is a diagram illustrating an example travel path 110 of a vehicle 102, including wireless network availability 130 along the travel path 110. In this example, a delivery vehicle 102 is transporting cargo from a warehouse 112 to a destination in City B 116. During this travel, the vehicle 102 moves from the warehouse 112 through City A 114, and through to City B 116, as illustrated by the travel path 110. Further, the vehicle 102 includes a mobile device (not separately shown in FIG. 1) that is configured to wirelessly connect and communicate with a cellular network, “Cell Network A” 120 (e.g., a particular cellular network provider). This particular network provider, Cell Network A 120, operates and maintains three cell towers along this particular travel path 110, namely cell tower “1” 122, cell tower “2” 124, and cell tower “3” 126.

At the warehouse 112, the vehicle 102 is located within a coverage area “1” 132 provided by cell tower “1” 122, and thus the mobile device connects to Cell Network A 120 via cell tower “1” 122. Upon embarking on this example delivery, the vehicle 102 eventually leaves coverage area “1” 132 while traveling between the warehouse 112 and City A 114 (as indicated by shaded area of network availability 130 between coverage area “1” 132 and coverage area “2” 134). During this portion of the travel path 110, the mobile device of the vehicle 102 is unable to communicate with Cell Network A 120, as that network provides no cellular coverage over that portion of the travel path 110. In this example, the only connectivity options for the vehicle 102 would be another cellular network (not shown in FIG. 1), if any happen to be available. Roaming networks, in this example, are non-contracted networks. Roaming networks are typically not optimal for mobile device connectivity, as they can incur additional charges for connectivity, data transfer, and the like. The data transfer rate and cost may be unknown to the mobile device and may be a higher cost than the contracted network (e.g., Cell Network A 120).

When the vehicle 102 enters into coverage area “2” 134 (e.g., as the vehicle 102 nears City A 114), the mobile device of the vehicle 102 reestablishes connectivity to Cell Network A 120 via cell tower “2” 124 (which provides the coverage area “2” 134). As such, the vehicle 102 maintains network connectivity while passing through City A 114 and departs for City B 116. At some point, the vehicle 102 travels out of the coverage area “2” 134 and, as above, again loses connectivity to Cell Network A 120 (as indicated by shaded area of network availability 130 between coverage area “2” 134 and coverage area “3” 136). Upon nearing City B 116, the vehicle 102 enters coverage area “3” 136, and the mobile device of the vehicle 102 again reestablishes connectivity with Cell Network A 120 via cell tower “3” 126 (which provides the coverage area “3” 136), thereafter arriving at its intended destination in City B 116.

As such, in this example, the vehicle 102 lost wireless network connectivity at various stages of the travel path 110. Such connectivity loss between the vehicle 102 and remote systems can cause logistical issues with managing the vehicle 102 or its cargo. However, additional wireless network connectivity options may be available to the vehicle 102 along this travel path 110. It would be advantageous to provide a system that can manage network connectivity for mobile devices as they travel.

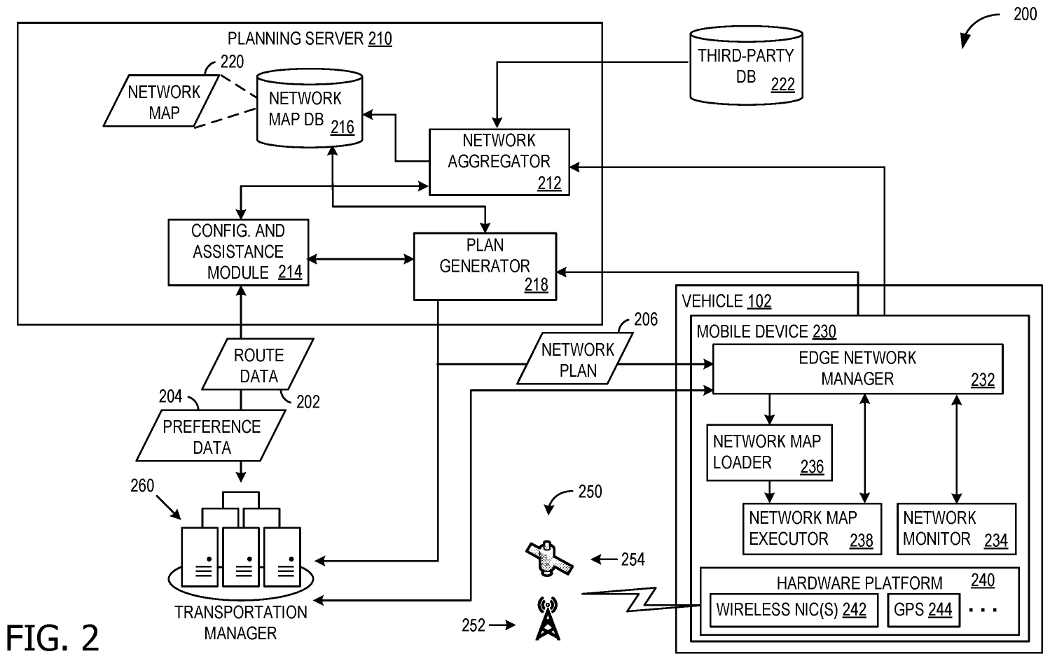

FIG. 2 is an architectural diagram illustrating an example dynamic network planning system 200 for managing network connectivity of a mobile edge device 230. In examples, the mobile device 230 is a computing device installed on a vehicle or cargo unit, such as the vehicle 102 of FIG. 1. In this example, the vehicle 102 is monitored and managed by the network planning system 200 as the vehicle 102 travels a travel path such as the example travel path 110 of FIG. 1. The network planning system 200 provides a planning server 210 that is configured to create a network connectivity plan (or just “network plan”) 206 for the mobile device 230 of the vehicle 102 based on the anticipated travel path 110 of that vehicle 102. The network connectivity plan 206 defines which network(s) 250 the mobile device 230 is to use for wireless network connectivity along various segments of the travel path 110, both for preferred networks, as well as for secondary networks (e.g., when a more preferred network is not available). This network connectivity plan 206 is downloaded to the mobile device 230 (e.g., prior to beginning a trip) and is used by the mobile device 230 to manage its own network connectivity to various wireless networks during travel.

During a planning phase, the planning server 210 identifies travel route information (e.g., route data 202) for a trip that is planned for the vehicle 102 and its associated mobile device 230. In examples, the route data 202 is received by a configuration and assistance module 214 (e.g., in response to input from the transportation manager 260 during route planning). The route data 202 defines a travel path upon which the vehicle 102 is anticipated to travel, such as the travel path 110 of FIG. 1. The route data 202 can include, for example, start and end destination locations for the trip, segments of the travel path (e.g., defined by starting and ending travel waypoints, perhaps identified by street/road/highway intersections, or the like), turn locations and directions (e.g., defined by street/road/highway intersections), or any such method for identifying and representing a travel path relative to a digital map or the like. In some examples, the route data 202 is provided by the transportation manager 260 (e.g., via a user-defined plan, perhaps using an Internet-based route generation service). In some examples, the route data 202 is provided as start and end destinations from the transportation manager, or from the mobile device 230 itself, and the planning server 210 is configured to communicate with an Internet-based route generation service to acquire the travel path, or the planning server 210 includes an internal route generator (not shown) that is configured to generate the travel path based on the provided start and end locations.

The planning server 210 provides a plan generator 218 that is configured to generate the network plan 206 based on the route data 202 for a given trip. For example, the plan generator 218 uses the route data 202 in conjunction with a network map 220 (e.g., provided by a network map DB 216) to determine which network(s) the mobile device 230 should use at which times during the trip. The network map 220 is a map that identifies areas of coverage for various wireless networks 250 (e.g., by geographic location). The plan generator 218 uses the network map 220, in conjunction with the route data 202 for the trip, to determine what network(s) 250 are available along each of the various segments of the travel path 110.

For example, with regard to various cellular networks 252, the network map 220 identifies geographic locations of various cellular towers (e.g., by GPS location), as well as tower data for each tower, such as, for example, signal distance limits that define how far the mobile device 230 can reliably connect to that tower, perhaps based on type of urban/suburban/rural area, to what cellular network 252 that tower belongs. With regard to various satellite networks 254, the network map 220 may identify a coverage area for the satellite network 254 (e.g., by geofencing, by country, state, or any such predefined boundary). In some examples, the planning server 210 collects data from third party databases 222 (e.g., to build the network map 220). As such, the plan generator 218 uses the route data 202 to identify which network(s) 250 are available at various segments along the travel path 110 (e.g., based on what networks 250 are anticipated to be available, as defined by the network map 220 along that segment). Such analysis identifies network availability data for each of the travel segments along the path 110.

The plan generator 218 uses this network availability data to generate network connectivity preferences for each of the travel segments. For example, the planning server 210 identifies network preference data 204 (e.g., preferred network settings, parameter prioritization, or other such configurations) that are defined in the system 200 (e.g., by the transportation manager). The preference data 204 defines what network(s) 250 are preferred over other networks 250. For example, the transportation manager 260 has contracted with a particular cellular network provider (e.g., Cell Network A 120) for connecting all of their mobile devices 230 in their fleet of vehicles 102. Other cellular networks 252 may be available across various segments of the travel path 110, but connectivity to such other networks 252 may incur additional costs. As such, the plan generator 218 uses the preference data 204 to identify, at each segment of the travel path 110, which networks 250 are available, and to order those available networks 250 based on the preference data 204 (e.g., as a network preference list for that segment).

For example, during traversal of a first segment of the path 110, the preferred cellular network is available, a secondary cellular network is also available, and a satellite network 254 is also available. As such, the plan generator 218 includes, in the network plan 206 for this segment, an ordered list of the first (preferred) cellular network, the second cellular network (e.g., as a more expensive option than the preferred cellular network, but less expensive than satellite network), and the satellite network (e.g., as a most expensive option, as a connectivity option that supports a lower bandwidth, or some other diminished capacity relative to the other network(s) 250). In examples, each travel segment is delineated by connectivity waypoints identified during this analysis. The connectivity waypoints represent a geographic location (e.g., somewhere along the travel path 110) at which network connectivity is planned to transition between one segment (e.g., one list of networks 250) to another segment (e.g., perhaps a different list of networks 250). As such, each travel segment in the network plan 206 may be bounded by two such connectivity waypoints, one at the beginning of the segment (e.g., as the vehicle 102 would be entering into a coverage area for a particular set of networks 250) and another at the end of the segment (e.g., as the vehicle 102 would be exiting that coverage area for that set of networks 250). Accordingly, the plan generator 218 defines a preferred order list for networks over each of the segments of the planned travel path 110, as well as the connectivity waypoint(s) that bound the segment in this network plan 206.

In some examples, the planning server 210 sends the network plan 206 to the mobile device 230 for implementation. The mobile device 230 includes a hardware platform 240 that provides computing hardware that support the computing functions, systems, and methods described herein. The mobile device 230 includes one or more wireless network interface 242, such as a cellular adapter or cellular modem (e.g., a network interface that enables wireless connectivity to cellular phone networks, such as a 3G/4G/5G cellular networks, or the like), a long range (LoRa) module or chip (e.g., a network interface that enables wireless connectivity to Internet-of-Things (IoT) devices and networks, terrestrially or satellite) and/or a satellite modem or satellite terminal (e.g., a network interface that enables wireless connectivity and communication via satellite networks, such as via low-earth orbit (LEO) satellite Internet constellations, geostationary Internet satellites, or the like). Such wireless NICs 242 allow the mobile device 230 to wirelessly communicate with wireless networks 250 and their associated hardware, such as cellular networks 252 (e.g., cell towers 122-126) or satellite networks 254. It is presumed that any or all of the communications described herein as occurring between the mobile device 230 and the planning server 210 or the transportation manager 260 occurs over these wireless networks 250. Further, it is also presumed that the wireless NICs 242 that connect to cellular networks 252 can potentially connect to multiple different cellular network providers (e.g., different cellular networks 252).

The hardware platform 240 of the mobile device 230 also includes a global positioning system (GPS) receiver (or just “GPS”) 244, and associated antenna (not separately shown), that can wirelessly determine current geolocation information for the mobile device 230 and vehicle 102 (e.g., via triangulation with various GPS satellites). The hardware platform 240 can also include, for example, one or more processors, memory devices, storage devices, communications devices, display devices, and the like, none of which are separately shown in FIG. 2 for purposes of brevity.

FIG. 2 also depicts several software components operating on the mobile device 230, namely an edge network manager 232, a network monitor 234, a network map loader 236, and a network map executor 238. The edge network manager 232 is configured to receive the network plan 206 and initiate implementation of that network plan 206 (e.g., during a travel phase, as the vehicle 102 traverses the travel path 110). In some examples, the network plan 206 is loaded by a network map loader 236 (e.g., reading the various travel segments and their associated ranked lists of network preferences) and a network map executor 238 is configured to implement the network plan 206. The network map executor 238 initially identifies a current location of the vehicle 102 (e.g., via location data provided by GPS 244) and determines within which segment of the network plan 206 the vehicle 102 is currently positioned (e.g., based on minimum distances between the various connectivity waypoints of the network plan 206).

Upon identifying this current segment, the network map executor 238 attempts to connect to the most preferred network. The network map executor 238 performs a network scan (e.g., a signal search for cell towers, satellite accessibility, or the like) to identify wireless networks 250 that are currently accessible by the mobile device 230. The network map executor 238 uses the network preference list to identify the most preferred network for this current segment. If the most preferred network is currently accessible, the network map executor 238 causes the mobile device 230 to connect with that most preferred network. In situations where the most preferred network is not currently accessible, the network map executor 238 evaluates the availability of the next network in the list and, if currently available, connects to that next network. As such, the network map executor 238 works down the network preference list for that segment until a connection is established to one of the available networks 250.

While the vehicle 102 is traveling, the mobile device 230 periodically passes the network connectivity waypoints contained in the network plan 206, each of which may cause the mobile device 230 to change networks 250. When a particular connectivity waypoint defined in the network plan 206 is encountered (e.g., based on current GPS location of the vehicle 102 along the travel path 110), the network map executor 238 triggers a network transition event to be processed. The network transition event causes the network map executor 238 to evaluate current network availability relative to network preference list of the next segment (e.g., the segment that the vehicle 102 is now entering). As above, the network map executor 238 performs a network scan to identify which wireless networks 250 are currently available. If the primary network for that segment is available, the network map executor 238 causes the mobile device 230 to connect to that preferred network. And as above, when the most preferred network is not available, the network map executor 238 moves to the next most preferred network in the list for that segment and attempts to connect to that network 250, if available.

As such, the mobile device 230 uses the network plan 206 to manage network connectivity through a particular travel path 110, transitioning between networks 250 based on current availability of those networks 250 at various locations, and in a preferred priority. This dynamic connectivity ensures that the mobile device 230 retains network connectivity, where possible, while taking into account the priorities of the mobile device 230 (e.g., potentially minimizing cost, maximizing favored functionalities, or other such benefits).

In some examples, the planning server 210 generates one or more additional (“contingency”) network plans 206 for certain contingencies. For example, if the vehicle 102 were to deviate from an initial travel path 110 (e.g., to avoid traffic or a potentially hazardous road condition), the new path 110 includes different segments, and thus potentially different network preference lists of networks 250 along those new segments. Some such situations may be anticipated by the planning server 210 (e.g., based on regular traffic times at particular areas, and known alternate travel paths to avoid those areas). Therefore, the planning server 210 may generate contingent network plans 206 for those alternate travel paths. These contingency network plans 206 may also be sent to the mobile device 230 and can be dynamically implemented by the mobile device 230 when deviation between travel paths 110 is detected.

During the travel phase, the edge network manager 232 receives network data from a network monitor 234. The network data represents a log of which network(s) 250 were available at various times and locations as the vehicle 102 traverses the travel path 110, and can include other network data such as signal strength at various locations, network performance at various times and locations (e.g., actual upload or download throughput experienced on particular networks), or the like. This network availability data is transmitted to a network aggregator 212 of the planning server 210 for aggregation. The network aggregator 212, for example, updates the network map 220 with network availability for various networks 250 at different locations (e.g., based on real world data collected from various mobile devices 230), thus allowing the planning server 210 to generate more accurate network plans 206 in the future.

In some examples, the mobile device 230 is a packaged computing device (not separately shown) that can be installed in commercial or private vehicles 102, such as manned or unmanned (e.g., autonomous) road-based cargo transportation vehicles (e.g., semi-trailer trucks, flatbed trucks, refrigerated trucks, box trucks, tanker trucks, dump trucks, vans, bulk carriers, car carriers, associated trailers, and the like), rail transportation vehicles (e.g., train engines, train cars), maritime transportation vehicles (e.g., commercial ships, private vessels), or aviation transportation vehicles (e.g., commercial airplanes, private airplanes). The packaged computing device can be powered by a power network provided by the vehicle 102 (e.g., via a 12-volt adapter, direct wiring into an onboard power circuit, or the like).

In some examples, the mobile device 230 also receives cargo data associated with cargo that is transported by the vehicle 102. For example, the vehicle 102 includes one or more sensors configured to collect data about the vehicle 102 and/or the cargo being transported by the vehicle 102, such as environmental data (e.g., temperature, humidity, pressure, light exposure, or the like), handling data (e.g., shock, vibration, tilt, orientation), container integrity (e.g., door sensors, seal integrity), and vehicle performance data (e.g., speed and driving data, fuel consumption). Such data may be transmitted to the transportation manager 260 (e.g., for monitoring of the vehicle 102 and its cargo) via the wireless network(s) 250 and the connectivity to those networks 250 as managed by the mobile device 230. Such network management offered by the mobile device 230 provides greater reliability of connectivity between the mobile device 230 and the transportation manager 260, and thus more regular and reliable access to vehicle and cargo data (e.g., for real-time monitoring).

In some examples, the mobile device 230 uses the network plan 206 to affect other applications executing on the mobile device 230. For example, presume a user of the mobile device 230 is executing a large language model (LLM) application, which can provide query responses to user queries using a cache or a small model made locally available on the mobile device 230 (which uses local computational resources but little or no network bandwidth) or perform queries to an LLM through network requests and responses (which uses significant network bandwidth). As such, the network plan 206 may be used to determine whether to perform the LLM queries locally (e.g., if the preferred network or the current network are low-bandwidth, high-latency, and/or high-cost networks) or to perform more the network intensive query to the LLM. In some examples, the mobile device 230 triggers a network transition event based on application demand. For example, presume the mobile device 230 executes another application, such as a video streaming service (e.g., generating significant network bandwidth) or a wireless voice-over-IP (VOIP) call (e.g., generating some network bandwidth, but more negatively impacted by high latency). As such, the mobile device 230 may trigger a network transition event based on these application needs, transitioning between networks 250 based on current availability of those networks 250 at various locations, in the preferred priority, but using the limitations of those networks in relation to the needs of the application (e.g., selecting a network based on bandwidth or latency requirements of the application). For example, a user is using a mobile device while in a moving vehicle, and wishes to query a chatbot. Aspects of the disclosure use the network map to determine if the mobile device should use a cache on the mobile device, a smaller model on the mobile device, or a larger model in the cloud.

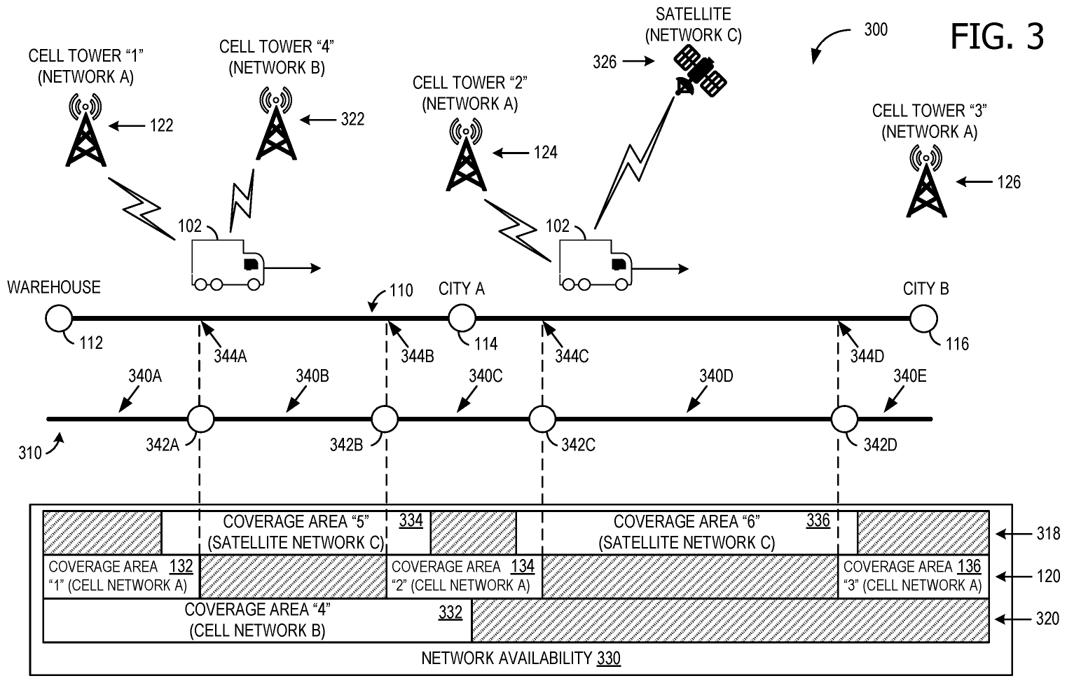

FIG. 3 is a diagram illustrating the example travel path 110 of the vehicle 102 of FIG. 1, showing wireless network availability 330 of multiple wireless networks 250 along the travel path 110. Like the example of FIG. 1, the delivery vehicle 102 is transporting cargo from a warehouse 112 to a destination in City B 116. In the example shown in FIG. 3, the vehicle 102 includes the mobile device 230, which allows the mobile device 230 to communicate with wireless networks, including Cell Network A 120, a “Cell Network B” 320, and “Satellite Network C” 318. Cell Network A 120 and Cell Network B 320 are example cellular networks 252, where Cell Network A 120 is a preferred network in this example. Like the example of FIG. 1, Cell Network A 120 includes cell tower “1” 122, cell tower “2” 124, and cell tower “3” 126. Cell Network B 320 includes a cell tower “4” 322 that provides coverage between the warehouse 112 and City A 114. Satellite Network C 318 includes one or more satellites 326 that provide coverage between cities, but may not provide ample coverage within certain areas of cities (e.g., due to obstruction by buildings or the like). Each of these networks 120, 320, 318 can have differing properties, such as, for example, data transfer rate, data transfer cost, connectivity range, latency, or other costs.

In this example, the vehicle 102 participates in the network planning system 200 of FIG. 2. Like the example of FIG. 1, the vehicle 102 has a planned travel path 110 for this trip, namely from the warehouse 112 through City A 114, and through to City B 116, as illustrated by the travel path 110. This example travel path 110 can include many travel waypoints (not shown) that, for example, define when the vehicle 102 should make turns onto other streets, roads, or highways while traveling to the destination.

At or prior to the beginning of this trip, the planning server 210 uses the travel path 110 to generate an initial network plan 206 for this vehicle 102 and this trip. As described above in FIG. 2, the planning server 210 uses the network map 220 in conjunction with the travel path 110 for this trip to generate the network plan 206. In this example, network availability 330 illustrates which networks 120, 320, 318 are available along which portions of the travel path 110. In this example, Cell Network A 120 provides coverage area “1” 132 around the warehouse 112, coverage area “2” 134 around City A 114, and coverage area “3” around City B 116. Cell Network B 320 provides a coverage area “4” 332 that covers a region between the warehouse 112 and City A 114. Satellite Network C 318 provides a coverage area “5” 334 along a portion of the travel path 110, 310 between the warehouse 112 and City A 114, as well as a coverage area “6” 336 along a portion of the travel path 110, 310 between City A 114 and City B 116. All of these coverage areas are presumed to be defined by or otherwise determinable from the network map 220.

During the planning phase for this trip, the planning server 210 generates a set of connectivity waypoints 342A-342D along a connectivity travel path 310 (e.g., mirroring travel path 110, but shown separately in FIG. 3 for purposes of illustration). Each connectivity waypoint 342A-342D represents a point along the travel path 110, 310 at which the mobile device 230 should transition between networks. To determine these connectivity waypoints 342A-342D, the planning server 210, for example, virtually traverses the travel path 110, using the network map 220 to determine which networks 120, 320, 318 are available along each portion of the travel path 110. In some examples, the planning server 210 builds a coverage graph such as the network availability 330 shown in FIG. 3. In some examples, the planning server 210 finds a closest entry in the network map 220 for each coordinate in a given path, then identify the available connectivity options at that location. These options may be ranked based on lowest cost, highest data rate, lowest power consumption, or some weighted aggregate score (e.g., based on which parameters are favored over others). These options may be provided as a ranked list of connectivity options for each geolocation on the path.

For example, the planning server 210 begins at the warehouse 112 on the travel path 110 and identify which networks are expected to be available at that location (e.g., based on the network map 220). In this example, the location of the warehouse 112 is covered by coverage area “1” for Cell Network A 120, as well as coverage area “4” for Cell Network B 320. The planning server 210 may start traversing the travel path 110 (e.g., in predefined increments, such as 1-mile increments). In early portions of the travel path 110, both coverage area “1” 132 and coverage area “4” 332 continue to provide overlapping coverage. At some point along the path 110, coverage area “5” 334 of Satellite Network C 318 also provides overlapping coverage. However, eventually the travel path 110, 310 reaches a point 344A at which coverage area “1” 132 no longer provides coverage. Since Cell Network A 120 is the preferred network for this transportation manager 260, and since that Cell Network A 120 is either losing coverage or gaining coverage at this point 344A (e.g., losing coverage at this stage of the trip), the planning server 210 generates a first connectivity waypoint 342A at this approximate location (e.g., where signal strength of cell tower “1” 122 is anticipated to be below a predetermined threshold, or the like). As such, the planning server 210 also generates a travel segment 340A that effectively starts at the beginning of this trip (e.g., at the warehouse 112) and ends at waypoint 342A (e.g., point 344A of the travel path 110). For this first segment 340A, the planning server 210 generates a network preference list based on the network(s) available within that segment 340A, and based on the preference data 204 provided for this trip. In this example, the network preference list for the first segment 340A includes an ordered list of Cell Network A 120 (e.g., as the preferred provider), Cell Network B 320 (e.g., as a secondary provider), and possibly Satellite Network C 318 (e.g., as a highest cost, lowest performance option). Satellite networks typically offer the largest coverage range when compared to cellular or other wide area networks, but at a higher cost and lower performance (e.g., lower data rates).

Continuing this example, the planning server 210 begins a second segment 340B that effectively starts at the first waypoint 342A (e.g., point 344A of the travel path 110). At this stage of the trip, both coverage area “4” and coverage area “5” are available until point 344B. At point 344B, Cell Network A 120 again becomes available (e.g., via coverage area “2” 134) and, as such, the planning server 210 creates a second waypoint 342B at that point 344B of the travel path 110, 310. For this second segment 340B, the planning server 210 creates a second network preference list that identifies Cell Network B 320 as the first network and the Satellite Network C 318 as the second network in the list (e.g., because Cell Network B 320 is a lower-cost or higher-performance option over the Satellite Network C 318).

Similarly, the planning server 210 identifies a third connectivity waypoint 342C where coverage area “2” 134 for Cell Network A 120 ends (e.g., at point 344C of the travel path 110, 310) and builds a third network preference list identifying Cell Network A 120, Cell Network B 320, and Satellite Network C 318, in that order. Likewise, a fourth waypoint 342D is identified where the Cell Network A 120 again has coverage at coverage area “3” 136, and a list for a fourth segment 340D is created by the planning server 210 to include only Satellite Network C 336 (as there is no cellular coverage during this segment 340D). The planning server 210 creates a fifth segment 340E when the end of the travel path 110 is achieved, creating a fifth network preference list to include Cellular Network A 120 as first in the list, and optionally Satellite Network C 318.

In this example, the planning server 210 creates the network plan 206 for this trip using the connectivity waypoints 342 (e.g., 342A-342D) and segments 340 (e.g., 340A-340E) identified during the planning phase. This network plan 206 may also include the travel path 110, which may be used by the vehicle 102 or its driver during the trip. The planning server 210 transmits the network plan 206 to the mobile device 230 for execution.

During a travel phase, the vehicle 102 starts this example trip at the warehouse 112. At this stage, the mobile device 230 begins monitoring wireless network availability and determines that the vehicle 102 is in range of cell tower “1” 122 of Cell Network A 120 and cell tower “4” 322 of Cell Network B 320. The mobile device 230 determines a current location of the vehicle 102 using GPS 244 and determines that the vehicle 102 is currently within the first segment 340A of the network plan 206 (e.g., based on minimum distance determination between the current location and a start location and the first waypoint 342A as compared to current distances to the other waypoints 342B-342E and the end destination). As such, the mobile device 230 identifies the first network preference list associated with the first segment 340A to use for network selection. As such, since the first network provided in the first network preference list is available (e.g., Cell Network A 120), the mobile device 230 connects with Cell Network A 120 via cell tower “1” 122.

As the vehicle 102 begins the trip, the mobile device 230 continues to collect current location information for the vehicle 102 and evaluate that current location against the next connectivity waypoint identified in the network plan 206 (e.g., the first waypoint 342A of the first segment 340A, the “current segment” at this time). The mobile device 230 periodically computes the location of the vehicle 102 relative to the travel path 110, 310 and, more particularly, relative to the next connectivity waypoint 342A and the next segment 340B. For example, the mobile device 230 computes a current distance between the current location of the vehicle 102 and the location of the next waypoint 342A and initiate a network transition event when that distance begins to rise (e.g., after the vehicle 102 has passed the waypoint 342A).

When the mobile device 230 initiates a network transition event, the mobile device 230 identifies the next network preference list associated with the next segment (e.g., the second segment 340B), similarly scans for accessibility of wireless networks, and changes network connectivity from the previous network to a new network. In this second segment 340B, the mobile device 230 executes a network transition event at point 344A of the travel path 110, 310 (e.g., at or around waypoint 342A), disconnecting from Cell Network A 120 and connecting to Cell Network B 320 (e.g., the top network listed in the list for this second segment 340B that is accessible). Similarly, the mobile device 230 continues to monitor the current location of the vehicle 102 until the next waypoint (e.g., second waypoint 342B) is reached. At that time, the mobile device 230 scans for network availability, disconnects from Cell Network B 320, and reconnects to Cell Network A 120 at point 344B of the travel path 110, 310. This position monitoring and evaluation of the waypoints 342 continue to be monitored by the mobile device 230, shifting between networks at each new waypoint 342 as they are encountered, and as defined by the network plan 206, until the vehicle 102 concludes the trip. If the vehicle 102 were to make a return journey, the same network plan 206 could be used in reverse if the same priorities and route are maintained.

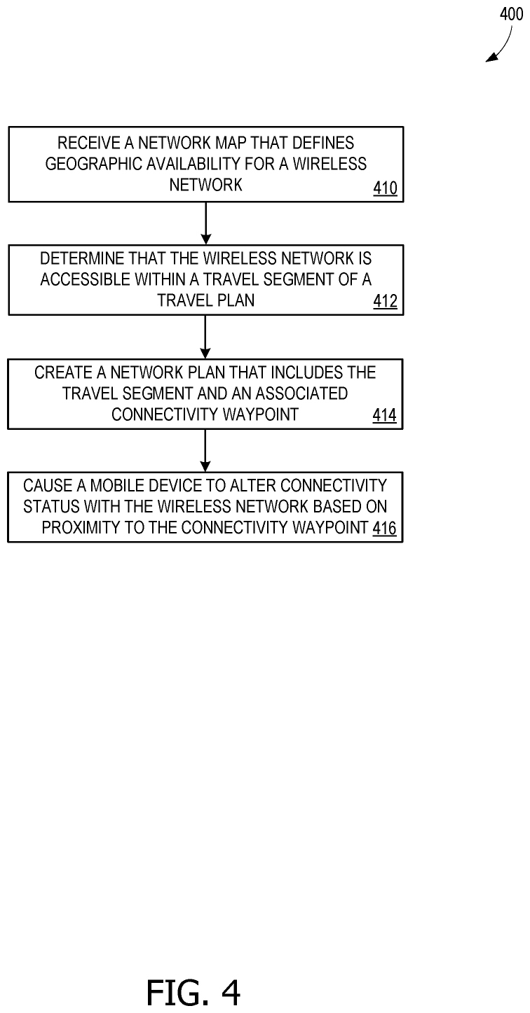

FIG. 4 is a flow chart 400 of an example method for managing wireless network connectivity for a mobile device. In examples, the method is performed by the planning server 210 and/or with the mobile device 230 (e.g., before and/or while the vehicle 102 transits the travel path 110, 310 of FIG. 1 and FIG. 3), and these operations may be similar to the operations shown and described in relation to FIG. 1 to FIG. 3. In this example, at operation 410, the planning server 210 receives a network map (e.g., network map 220 of FIG. 2) that defines geographic availability of a first wireless network (e.g., Cell Network A 120 of FIG. 1, wireless networks 250 of FIG. 2). At operation 412, the planning server 210 determines that the first wireless network is accessible within a travel segment (e.g., segment 340A of FIG. 3) of a travel plan (e.g., travel path 110, 310) based on comparing geographic location data associated with the travel segment to the geographic availability of the first wireless network from the network map.

At operation 414, the planning server 210 creates a network plan (e.g., network plan 206 of FIG. 2) that includes the travel segment and an associated connectivity waypoint (e.g., connectivity waypoint 342A of FIG. 3), the connectivity waypoint defining when to alter connectivity status with the first wireless network. In some examples, creating the network plan further includes creating an ordered list of wireless networks for the travel segment, the ordered list of wireless networks being ordered based on at least one network preference criterion.

At operation 416, the planning server 210 causes the mobile device 230 to alter connectivity status with the first wireless network based on proximity to the connectivity waypoint. In some examples, proximity to the connectivity waypoint is determined based on determining that a current distance to the connectivity waypoint is increasing. In some examples, the planning server 210 causes the mobile device 230 to alter connectivity status with the first wireless network by transmitting the network plan to the mobile device 230, wherein the network plan represents instructions to the mobile device 230 on when to alter connectivity with the first wireless network. In some examples, the planning server 210 also causes the mobile device to disconnect with the first wireless network, and causes the mobile device to connect with a second wireless network identified by the network plan.

In some examples, the planning server 210 also receives network connectivity preference data (e.g., preference data 204 of FIG. 2) identifying at least one criterion for selection of wireless network connectivity, and identifies the first wireless network as a preferred network over at least one other wireless network based on the network connectivity preference data. In some examples, the planning server 210 also causes the mobile device to connect to a second wireless network identified by the network plan for the travel segment when the first wireless network is unavailable. In some examples, the method further includes receiving, by the mobile device, the network plan, and connecting, by the mobile device, to a second wireless network when the mobile device has traveled past the connectivity waypoint.

### ADDITIONAL EXAMPLES

An example network planning system comprises: at least one processor; and at least one memory comprising computer-readable instructions, the at least one processor, the at least one memory and the computer-readable instructions configured to cause the at least one processor to: identify a network map that defines geographic availability of a first wireless network; determine that the first wireless network is accessible within a travel segment of a travel plan based on comparing geographic location data associated with the travel segment to the geographic availability of the first wireless network from the network map; generate a network plan that includes the travel segment and an associated connectivity waypoint, the connectivity waypoint defining when to alter connectivity status with the first wireless network; and cause a mobile device to alter connectivity status with the first wireless network based on proximity to the connectivity waypoint.

An example method for managing wireless network connectivity for a mobile device comprises: receiving a network map that defines geographic availability of a first wireless network; determining that the first wireless network is accessible within a travel segment of a travel plan based on comparing geographic location data associated with the travel segment to the geographic availability of the first wireless network from the network map; creating a network plan that includes the travel segment and an associated connectivity waypoint, the connectivity waypoint defining when to alter connectivity status with the first wireless network; and causing the mobile device to alter connectivity status with the first wireless network based on proximity to the connectivity waypoint.

An example computer storage medium has computer-executable instructions that, upon execution by a processor of a computer, cause the processor to at least: identify a network map that defines geographic availability of a first wireless network; determine that the first wireless network is accessible within a travel segment of a travel plan based on comparing geographic location data associated with the travel segment to the geographic availability of the first wireless network from the network map; generate a network plan that includes the travel segment and an associated connectivity waypoint, the connectivity waypoint defining when to alter connectivity status with the first wireless network; and cause a mobile device to alter connectivity status with the first wireless network based on proximity to the connectivity waypoint.

An example mobile computing device comprises: a wireless network interface; a processor; and a memory comprising computer-readable instructions, the processor, the memory and the computer-readable instructions configured to cause the processor to: receive a network plan that includes a travel segment, a connectivity waypoint, and an ordered list of wireless networks, the connectivity waypoint defining when to alter connectivity status, the ordered list of wireless networks being ordered based on a network preference criterion; alter connectivity status between the wireless network interface and a first wireless network of the ordered list of wireless networks based on proximity to the connectivity waypoint; and alter an operational parameter of an application executing on the mobile computing device based on a performance characteristic of the first wireless network.

An example computer-implemented method comprises: receiving a network plan that includes a travel segment, a connectivity waypoint, and an ordered list of wireless networks, the connectivity waypoint defining when to alter connectivity status, the ordered list of wireless networks being ordered based on a network preference criterion; altering connectivity status between the wireless network interface and a first wireless network of the ordered list of wireless networks based on proximity to the connectivity waypoint; and altering an operational parameter of an application executing on the mobile computing device based on a performance characteristic of the first wireless network.

An example computer storage medium has computer-executable instructions that, upon execution by a processor of a computer, cause the processor to at least: receive a network plan that includes a travel segment, a connectivity waypoint, and an ordered list of wireless networks, the connectivity waypoint defining when to alter connectivity status, the ordered list of wireless networks being ordered based on a network preference criterion; alter connectivity status between the wireless network interface and a first wireless network of the ordered list of wireless networks based on proximity to the connectivity waypoint; and alter an operational parameter of an application executing on the mobile computing device based on a performance characteristic of the first wireless network.

An example mobile computing device comprises: a wireless network interface; a processor; and a memory comprising computer-readable instructions, the processor, the memory and the computer-readable instructions configured to cause the processor to: receive a network plan that includes a travel segment, a connectivity waypoint, and an ordered list of wireless networks, the connectivity waypoint defining when to alter connectivity status, the ordered list of wireless networks being ordered based on a network preference criterion; alter connectivity status between the wireless network interface and a first wireless network of the ordered list of wireless networks based on proximity to the connectivity waypoint; determine that an application has been started on the mobile device; and based on resource demands of the application, alter connectivity status between the wireless network interface and a second wireless network of the ordered list of wireless networks.

Alternatively, or in addition to the other examples described herein, examples include any combination of the following:
receiving a network map that defines geographic availability of a plurality of wireless networks;
a network map defines a location of at least one wireless cellular tower and a coverage distance of that cellular tower;
determining that a first wireless network is accessible within a travel segment of a travel plan based on comparing geographic location data associated with the travel segment to the geographic availability of the first wireless network from the network map;
creating a network plan that includes the travel segment and an associated connectivity waypoint;
a connectivity waypoint defining when to alter connectivity status with the first wireless network;
causing the mobile device to alter connectivity status with the first wireless network based on proximity to the connectivity waypoint;
determining a current location based on a minimum distance determination between a plurality of connectivity waypoints;
creating a network plan that includes a plurality of segments of a travel path;
associating one or more connectivity waypoints with each segment of a travel path;
associating an ordered list of preferred wires networks with each segment of a travel path;
receiving network connectivity preference data identifying at least one criterion for selection of wireless network connectivity;
network connectivity preference data identifying a preferred wireless network;
network connectivity preference data identifying relative factors including one or more of download bandwidth, upload bandwidth, connectivity cost, data rate cost;
identifying the first wireless network as a preferred network over at least one other wireless network based on the network connectivity preference data;
wherein creating a network plan further includes creating an ordered list of wireless networks for the travel segment, the ordered list of wireless networks being ordered based on at least one network preference criterion;
causing the mobile device to connect to a second wireless network identified by the network plan for the travel segment when the first wireless network is unavailable;
wherein proximity to the connectivity waypoint is determined based on determining that a current distance to the connectivity waypoint is increasing;
causing the mobile device to disconnect with the first wireless network;
causing the mobile device to connect with a second wireless network identified by the network plan;
receiving, by the mobile device, the network plan;
connecting, by the mobile device, to a second wireless network when the mobile device has traveled past the connectivity waypoint;
receive a network plan that includes a travel segment, a connectivity waypoint, and an ordered list of wireless networks, the connectivity waypoint defining when to alter connectivity status, the ordered list of wireless networks being ordered based on a network preference criterion;
alter connectivity status between the wireless network interface and a first wireless network of the ordered list of wireless networks based on proximity to the connectivity waypoint;
alter an operational parameter of an application executing on the mobile computing device based on a performance characteristic of the first wireless network;
receive a network plan that includes a travel segment, a connectivity waypoint, and an ordered list of wireless networks, the connectivity waypoint defining when to alter connectivity status, the ordered list of wireless networks being ordered based on a network preference criterion;
alter connectivity status between the wireless network interface and a first wireless network of the ordered list of wireless networks based on proximity to the connectivity waypoint;
determine that an application has been started on the mobile device;
based on resource demands of the application, alter connectivity status between the wireless network interface and a second wireless network of the ordered list of wireless networks; and
altering the connectivity status based on the resource demands of the application comprises selecting a large language model (LLM) to execute on the mobile computing device instead of an LLM in a cloud.

While the aspects of the disclosure have been described in terms of various examples with their associated operations, a person skilled in the art would appreciate that a combination of operations from any number of different examples is also within scope of the aspects of the disclosure.

### Exemplary Operating Environment

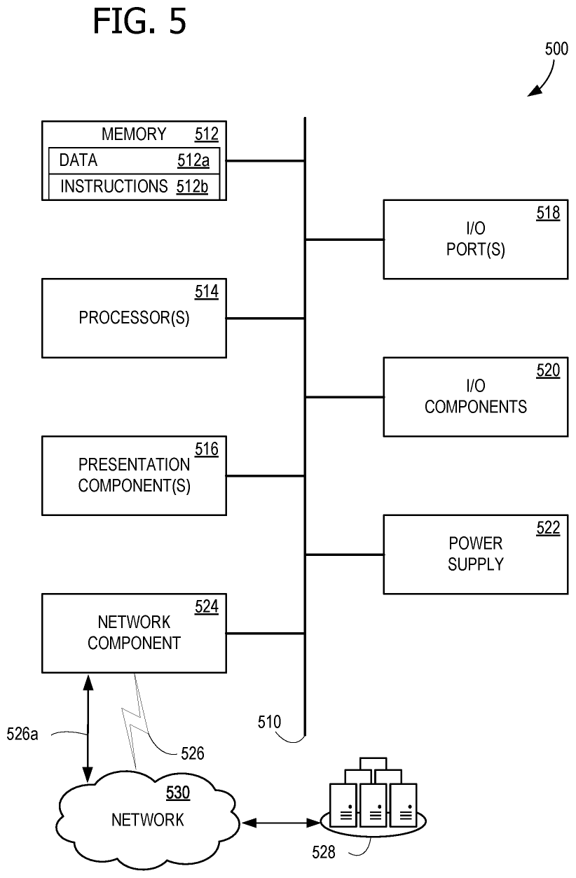

FIG. 5 is a block diagram of an example computing device 500 (e.g., a computer storage device) for implementing aspects disclosed herein, and is designated generally as computing device 500. In some examples, one or more computing devices 500 are provided for an on-premises computing solution. In some examples, one or more computing devices 500 are provided as a cloud computing solution. In some examples, a combination of on-premises and cloud computing solutions are used. Computing device 500 is but one example of a suitable computing environment that can be used in system 200 (e.g., as planning server 210, mobile device 230) and is not intended to suggest any limitation as to the scope of use or functionality of the examples disclosed herein, whether used singly or as part of a larger set. Neither should computing device 500 be interpreted as having any dependency or requirement relating to any one or combination of components/modules illustrated.

The examples disclosed herein may be described in the general context of computer code or machine-useable instructions, including computer-executable instructions such as program components, being executed by a computer or other machine, such as a personal data assistant or other handheld device. Generally, program components including routines, programs, objects, components, data structures, and the like, refer to code that performs particular tasks, or implement particular abstract data types. The disclosed examples may be practiced in a variety of system configurations, including personal computers, laptops, smart phones, mobile tablets, hand-held devices, consumer electronics, specialty computing devices, etc. The disclosed examples may also be practiced in distributed computing environments when tasks are performed by remote-processing devices that are linked through a communications network.

Computing device 500 includes a bus 510 that directly or indirectly couples the following devices: computer storage memory 512, one or more processors 514, one or more presentation components 516, input/output (I/O) ports 518, I/O components 520, a power supply 522, and a network component 524. While computing device 500 is depicted as a seemingly single device, multiple computing devices 500 may work together and share the depicted device resources. For example, memory 512 may be distributed across multiple devices, and processor(s) 514 may be housed with different devices.

Bus 510 represents what may be one or more busses (such as an address bus, data bus, or a combination thereof). Although the various blocks of FIG. 5 are shown with lines for the sake of clarity, delineating various components may be accomplished with alternative representations. For example, a presentation component such as a display device is an I/O component in some examples, and some examples of processors have their own memory. Distinction is not made between such categories as “workstation,” “server,” “laptop,” “hand-held device,” etc., as all are contemplated within the scope of FIG. 5 and the references herein to a “computing device.” Memory 512 may take the form of the computer storage media referenced below and operatively provide storage of computer-readable instructions, data structures, program modules and other data for the computing device 500. In some examples, memory 512 stores one or more of an operating system, a universal application platform, or other program modules and program data. Memory 512 is thus able to store and access data 512a and instructions 512b that are executable by processor 514 and configured to carry out the various operations disclosed herein.

In some examples, memory 512 includes computer storage media. Memory 512 may include any quantity of memory associated with or accessible by the computing device 500. Memory 512 may be internal to the computing device 500 (as shown in FIG. 5), external to the computing device 500 (not shown), or both (not shown). Additionally, or alternatively, the memory 512 may be distributed across multiple computing devices 500, for example, in a virtualized environment in which instruction processing is carried out on multiple computing devices 500. For the purposes of this disclosure, “computer storage media,” “computer-storage memory,” “memory,” and “memory devices” are synonymous terms for the computer-storage memory 512, and none of these terms include carrier waves or propagating signaling.

Processor(s) 514 may include any quantity of processing units that read data from various entities, such as memory 512 or I/O components 520. Specifically, processor(s) 514 are programmed to execute computer-executable instructions for implementing aspects of the disclosure. The instructions may be performed by the processor, by multiple processors within the computing device 500, or by a processor external to the client computing device 500. In some examples, the processor(s) 514 are programmed to execute instructions such as those illustrated in the flow charts discussed below and depicted in the accompanying drawings. Moreover, in some examples, the processor(s) 514 represents an implementation of analog techniques to perform the operations described herein. For example, the operations may be performed by an analog client computing device 500 and/or a digital client computing device 500. Presentation component(s) 516 present data indications to a user or other device. Exemplary presentation components include a display device, speaker, printing component, vibrating component, etc. One skilled in the art will understand and appreciate that computer data may be presented in a number of ways, such as visually in a graphical user interface (GUI), audibly through speakers, wirelessly between computing devices 500, across a wired connection, or in other ways. I/O ports 518 allow computing device 500 to be logically coupled to other devices including I/O components 520, some of which may be built in. Example I/O components 520 include, for example but without limitation, a microphone, joystick, game pad, satellite dish, scanner, printer, wireless device, etc.

Computing device 500 may operate in a networked environment via the network component 524 using logical connections to one or more remote computers. In some examples, the network component 524 includes a network interface card and/or computer-executable instructions (e.g., a driver) for operating the network interface card. Communication between the computing device 500 and other devices may occur using any protocol or mechanism over any wired or wireless connection. In some examples, network component 524 is operable to communicate data over public, private, or hybrid (public and private) using a transfer protocol, between devices wirelessly using short range communication technologies (e.g., near-field communication (NFC), Bluetooth™ branded communications, or the like), or a combination thereof. Network component 524 communicates over wireless communication link 526 and/or a wired communication link 526a to a remote resource 528 (e.g., a cloud resource) across network 530. Various different examples of communication links 526 and 526a include a wireless connection, a wired connection, and/or a dedicated link, and in some examples, at least a portion is routed through the internet.

Although described in connection with an example computing device 500, examples of the disclosure are capable of implementation with numerous other general-purpose or special-purpose computing system environments, configurations, or devices. Examples of well-known computing systems, environments, and/or configurations that may be suitable for use with aspects of the disclosure include, but are not limited to, smart phones, mobile tablets, mobile computing devices, personal computers, server computers, hand-held or laptop devices, multiprocessor systems, gaming consoles, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, virtual reality (VR) devices, augmented reality (AR) devices, mixed reality devices, holographic device, and the like. Such systems or devices may accept input from the user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions or the specific components or modules illustrated in the figures and described herein. Other examples of the disclosure may include different computer-executable instructions or components having more or less functionality than illustrated and described herein. In examples involving a general-purpose computer, aspects of the disclosure transform the general-purpose computer into a special-purpose computing device when configured to execute the instructions described herein.

By way of example and not limitation, computer readable media comprise computer storage media and communication media. Computer storage media include volatile and nonvolatile, removable and non-removable memory implemented in any method or technology for storage of information such as computer readable instructions, data structures, program modules, or the like. Computer storage media are tangible and mutually exclusive to communication media. Computer storage media are implemented in hardware and exclude carrier waves and propagated signals. Computer storage media for purposes of this disclosure do not include signals. Exemplary computer storage media include hard disks, flash drives, solid-state memory, phase change random-access memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that may be used to store information for access by a computing device. In contrast, communication media typically embody computer readable instructions, data structures, program modules, or the like in a modulated data signal such as a carrier wave or other transport mechanism and include any information delivery media.

The order of execution or performance of the operations in examples of the disclosure illustrated and described herein is not essential, and may be performed in different sequential manners in various examples. For example, it is contemplated that executing or performing a particular operation before, contemporaneously with, or after another operation is within the scope of aspects of the disclosure. When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of.” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A network planning system comprising:
a processor; and
a memory comprising computer-readable instructions, the processor, the memory and the computer-readable instructions configured to cause the processor to:
identify a network map that defines geographic availability of a first wireless network;
comparing geographic location data associated with a travel segment of a travel plan to the geographic availability of the first wireless network from the network map;
determine that the first wireless network is accessible within the travel segment based on the comparison;
generate a network plan that includes the travel segment and an associated connectivity waypoint, the connectivity waypoint defining when to alter connectivity status with the first wireless network; and
cause a mobile device to alter connectivity status with the first wireless network based on proximity to the connectivity waypoint.

2. The network planning system of claim 1, wherein the computer-readable instructions are further configured to cause the processor to:
receive network connectivity preference data identifying a criterion for selection of wireless network connectivity; and
identify the first wireless network as a preferred network over another wireless network based on the network connectivity preference data.

3. The network planning system of claim 1, wherein generating a network plan further includes generating an ordered list of wireless networks for the travel segment, the ordered list of wireless networks being ordered based on a network preference criterion.

4. The network planning system of claim 3, wherein the computer-readable instructions are further configured to cause the processor to cause the mobile device to connect to a second wireless network identified by the network plan for the travel segment when the first wireless network is unavailable.

5. The network planning system of claim 1, wherein the proximity to the connectivity waypoint is determined based on determining that a current distance to the connectivity waypoint is increasing.

6. The network planning system of claim 1, wherein causing the mobile device to alter connectivity status with the first wireless network further includes:
causing the mobile device to disconnect with the first wireless network; and
causing the mobile device to connect with a second wireless network identified by the network plan.

7. The network planning system of claim 1, further comprising:
the mobile device installed within a vehicle, the mobile device comprising:
a wireless network interface configured to connect with the first wireless network;
another processor; and
another memory comprising other computer-readable instructions, the other processor, the other memory and the other computer-readable instructions configured to cause the other processor to:
receive the network plan; and
connect to a second wireless network via the wireless network interface when the vehicle has traveled past the connectivity waypoint.

8. A computer-implemented method for managing wireless network connectivity for a mobile device, the method comprising:
receiving a network map that defines geographic availability of a first wireless network;
determining that the first wireless network is accessible within a travel segment of a travel plan based on a comparison of geographic location data associated with the travel segment to the geographic availability of the first wireless network from the network map;
creating a network plan that includes the travel segment and an associated connectivity waypoint, the connectivity waypoint defining when to alter connectivity status with the first wireless network; and
causing the mobile device to alter connectivity status with the first wireless network based on proximity to the connectivity waypoint.

9. The computer-implemented method of claim 8, further comprising:
receiving network connectivity preference data identifying a criterion for selection of wireless network connectivity; and
identifying the first wireless network as a preferred network over another wireless network based on the network connectivity preference data.

10. The computer-implemented method of claim 8, wherein creating a network plan further includes creating an ordered list of wireless networks for the travel segment, the ordered list of wireless networks being ordered based on a network preference criterion.

11. The computer-implemented method of claim 10, further comprising causing the mobile device to connect to a second wireless network identified by the network plan for the travel segment when the first wireless network is unavailable.

12. The computer-implemented method of claim 8, wherein the proximity to the connectivity waypoint is determined based on determining that a current distance to the connectivity waypoint is increasing.

13. The computer-implemented method of claim 8, wherein causing the mobile device to alter connectivity status with the first wireless network further includes:
causing the mobile device to disconnect with the first wireless network; and
causing the mobile device to connect with a second wireless network identified by the network plan.

14. The method of claim 8, further comprising:
receiving, by the mobile device, the network plan; and
connecting, by the mobile device, to a second wireless network when the mobile device has traveled past the connectivity waypoint.

15. A computer storage medium having computer-executable instructions that, upon execution by a processor of a computer, cause the processor to at least:
identify a network map that defines geographic availability of a first wireless network;
determine that the first wireless network is accessible within a travel segment of a travel plan based on comparing geographic location data associated with the travel segment to the geographic availability of the first wireless network from the network map;
generate a network plan that includes the travel segment and an associated connectivity waypoint, the connectivity waypoint defining when to alter connectivity status with the first wireless network; and
cause a mobile device to alter connectivity status with the first wireless network based on proximity to the connectivity waypoint.

16. The computer storage medium of claim 15, wherein the computer-executable instructions are further configured to cause the processor to:
receive network connectivity preference data identifying a criterion for selection of wireless network connectivity; and
identify the first wireless network as a preferred network over another wireless network based on the network connectivity preference data.

17. The computer storage medium of claim 15, wherein generating a network plan further includes generating an ordered list of wireless networks for the travel segment, the ordered list of wireless networks being ordered based on a network preference criterion.

18. The computer storage medium of claim 17, wherein the computer-executable instructions are further configured to cause the processor to cause the mobile device to connect to a second wireless network identified by the network plan for the travel segment when the first wireless network is unavailable.

19. The computer storage medium of claim 15, wherein the proximity to the connectivity waypoint is determined based on determining that a current distance to the connectivity waypoint is increasing.

20. The computer storage medium of claim 15, wherein causing the mobile device to alter connectivity status with the first wireless network further includes:
causing the mobile device to disconnect with the first wireless network; and
causing the mobile device to connect with a second wireless network identified by the network plan.
